(19) United States
(12) Patent Application Publication
(10) Pub. No.: US 2010/0302181 A1
(43) Pub. Date: Dec. 2, 2010

(54) TACTILE SENSOR MODULE HAVING UWB WIRELESS COMMUNICATION FUNCTION AND UWB COMMUNICATION METHOD USING THE TACTILE SENSOR MODULE

(75) Inventors: Jong Ho Kim, Daejeon (KR); Min Seok Kim, Daejeon (KR); Yon-Kyu Park, Daejeon (KR); Dae Im Kang, Daejeon (KR)

Correspondence Address: HISCOCK & BARCLAY, LLP, 2000 HSBC PLAZA, 100 Chestnut Street, ROCHESTER, NY, 14604-2404, US

(73) Assignee: Korea Research Institute of Standards and Science, Daejeon (KR)

(21) Appl. No.: 12/611,369

(22) Filed: Nov. 3, 2009

(30) Foreign Application Priority Data
Jun. 2, 2009 (KR) 10-2009-0048380

(51) Int. Cl. G06F 3/041; H04B 1/69

(52) U.S. Cl. 345/173; 375/130; 375/E01.001

(57) ABSTRACT

Disclosed herein are a tactile sensor module including a sensing unit connected to an external electronic device through a UWB communication network and a UWB communication method using the tactile sensor module. The tactile sensor module includes the sensing unit which has a plurality of sensor cells and outputs an output signal corresponding tactile information on a force applied thereto by a user using a pointing object, and a UWB based module which wirelessly connects the sensing unit to the external electronic device to construct a UWB communication network, receives external data in the form of a UWB wireless communication signal from the external electronic device, converts the output signal into data that can be recognized by the external electronic device and transmits the converted data to the external electronic device as a UWB wireless communication signal.

### CROSS-REFERENCE TO RELATED APPLICATIONS

This application is based on Korean Patent Application No. 10-20009-0048380 filed Jun. 2, 2009.

### BACKGROUND OF THE INVENTION

1. Field of the Invention

The present invention relates to a tactile sensor module having an ultra-wideband (UWB) wireless communication function, which includes a tactile sensor connected to an external electronic device through a UWB wireless communication network, and a UWB wireless communication method using the tactile sensor module. More specifically, the invention relates to a tactile sensor module including a sensing unit connected to an external electronic device through a UWB wireless communication network without using electric wires and transmitting an output signal sensed by the sensing unit to the external electronic device.

2. Background of the Related Art

An electronic device includes a tactile sensor and recognizes a force applied by a pointing object of a user through the tactile sensor to provide various interfaces to the user. However, a conventional tactile sensor has a large number of data signal lines. That is, the tactile sensor includes a considerably large number of input signals and output signals because the tactile sensor is constructed based on a multi-channel array form. A large number of signal lines deteriorate utilization of the tactile sensor. In the case of a robot employing the tactile sensor, particularly, the tactile sensor does not correctly recognize tactile information when the robot executes its function due to a large number of signal lines.

Furthermore, the conventional tactile sensor has the multi-channel array form, and thus a vast amount of data is transmitted. Accordingly, a tactile information transmission speed and a sensor reaction speed are reduced.

### SUMMARY OF THE INVENTION

Accordingly, the present invention has been made in view of the above-mentioned problems occurring in the prior art, and it is a primary object of the present invention to connect a tactile sensor to an external electronic device through a rapid short-distance wireless communication technique without using a wire.

In the present invention, the external electronic device and the tactile sensor are connected to each other using a UWB wireless communication technique as the rapid short-distance wireless communication technique. The UWB wireless communication technique is a short-distance communication technique capable of transmitting a large amount of information at a transmission rate of hundreds of Mbps (for example, 200 Mbps) in a distance of shorter than 10 m.

The transmission rate of the UWB wireless communication technique reaches about 200 Mbps that is higher than that of Bluetooth technology, which is currently widely used short-distance wireless communication, by several hundred times. The present invention uses a tactile sensor module having a UWB communication network including a UWB transmitter, a receiver and a sensing unit to solve the problem of the conventional tactile sensor. The external electronic device wirelessly is connected to the tactile sensor module having the UWB communication network to transmit tactile information sensed by the sensing unit to the external electronic device at an ultra-high speed to provide a more rapid and convenient interface to a user.

To accomplish the above object of the present invention, according to an aspect of the present invention, there is provided a tactile sensor module having an ultra-wideband (UWB) wireless communication function, which includes a sensing unit having a plurality of sensor cells sensing an external force applied thereto and outputting an output signal based on tactile information in proportion to the applied force; and a UWB wireless communication unit receiving the output signal, converting the received signal into a UWB wireless communication signal and transmitting the UWB wireless communication signal.

The UWB wireless communication unit includes a UWB receiver receiving external data in the form of a UWB wireless communication signal from an external electronic device and a UWB transmitter transmitting the output signal converted into the UWB wireless communication signal to the external electronic device.

The plurality of sensor cells of the sensing unit are connected through signal lines and the sensing unit transmits the output signal to the UWB wireless communication unit. The UWB transmitter transmits the output signal to the external electronic device as a UWB wireless communication signal.

The sensing unit may include a multiplexer. The multiplexer may be a relay multiplexer connected to the plurality of sensor cells and transmit an output signal corresponding to tactile information based on a force applied to a specific sensor cell to the UWB wireless communication unit.

The multiplexer may include a first multiplexer connected to the plurality of sensor cells through input signal lines and a second multiplexer connected to the plurality of sensor cells through output signal lines, each of the input signal lines has two terminals respectively capable of selecting an input and ground and each of the output signal lines has two terminal respectively capable of selecting an output and ground.

The UWB wireless communication unit may further include an A/D converter converting the output signal into a digital signal.

The UWB wireless communication unit may further include an operation processor converting the digital signal converted by the A/D converter into data that can be recognized by the external electronic device and transmitting the converted data to the UWB transmitter.

The UWB wireless communication unit may further include a controller which receives the UWB wireless communication signal received by the UWB receiver, controls the UWB transmitter to transmit the data converted by the operation processor to the external electronic device as a UWB wireless communication signal and controls the multiplexer to output the output signal to the UWB wireless communication unit.

The tactile sensor module may further include a power supply supplying power to the UWB wireless communication unit.

The external electronic device may be a robot capable of performing UWB wireless communication with the tactile sensor module.

The robot may have a plurality of tactile sensor modules having the UWB wireless communication function, which are attached to the surface of the robot, and an output signal corresponding to tactile information based on a force applied to the sensing unit may be transmitted to the robot as a UWB wireless communication signal to operate the robot.

The external electronic device may be a mobile communication terminal capable of performing UWB wireless communication with the tactile sensor module.

A touch screen of the mobile communication terminal may include a plurality of tactile sensor modules having the UWB wireless communication function and an output signal corresponding to tactile information based on a force applied to the sensing unit may be transmitted to the mobile communication terminal as a UWB wireless communication signal to provide various interfaces to a user.

According to another aspect of the present invention, there is provided a UWB communication method using a tactile sensor module having a UWB wireless communication function, which includes the steps of: receiving external data in the form of a UWB wireless communication signal from an external electronic device through a UWB receiver and constructing a UWB wireless communication network between a sensing unit and the external electronic device through a UWB wireless communication unit; applying a force to a specific sensor cell of the sensing unit through a pointing object by a user; controlling a first multiplexer connected to a plurality of sensor cells of the sensing unit through input signal lines and a second multiplexer connected to the plurality of sensor cells through output signal lines to scan the input signal lines and the output signal lines to obtain signal information data and outputting an output signal corresponding to tactile information based on the signal information data from the second multiplexer; amplifying the output signal output from the second multiplexer; converting the amplified output signal into a digital signal; converting the digital signal into data that can be recognized by the external electronic device; and transmitting the converted data to a UWB transmitter and controlling the UWB transmitter to transmit the converted data to the external electronic device as a UWB wireless communication signal.

The external electronic device may be a robot capable of performing UWB wireless communication with the tactile sensor module having the UWB wireless communication function.

The robot may have a plurality of tactile sensor modules having the UWB wireless communication function, which are attached to the surface of the robot, and an output signal corresponding to tactile information based on a force applied to the sensing unit may be transmitted to the robot to operate the robot.

The external electronic device may be a mobile communication terminal capable of performing UWB wireless communication with the tactile sensor module having the UWB wireless communication function.

A touch screen of the mobile communication terminal may include a plurality of tactile sensor modules having the UWB wireless communication function and an output signal corresponding to tactile information based on a force applied to the sensing unit may be transmitted to the mobile communication terminal to provide various interfaces to a user.

As described above, according to an embodiment of the present invention, the tactile sensor is connected to the external electrode device through the UWB communication technique without using a wire to transmit an output signal from the tactile sensor.

Furthermore, the tactile sensor and the external electronic device are wirelessly connected to each other using the UWB communication technique, and thus a large amount of information can be transmitted at a transmission rate of hundreds of Mbps in a distance shorter than 10 m. The transmission rate reaches about 200 Mbps that is much higher than that (about 1 Mbps) of Bluetooth currently widely used. The external electronic device and the tactile sensor module having the UWB communication network are wirelessly connected to each other, and thus tactile information sensed by the sensing unit can be transmitted to the external electronic device at a high speed to provide more rapid and convenient interfaces to the user.

Moreover, it is possible to manufacture a very small-sized UWB based module for connecting the sensing unit to the external electronic device through the UWB communication network, and thus a large-area tactile sensor having a UWB communication network can be produced. Though a conventional large-area sensing unit is connected to an electronic device through a vast number of wiring lines, the tactile sensor having the UWB communication network according to the present invention can be wirelessly connected to the electronic device without using an additional wire to rapidly transmit a vast amount of data to the electronic device. Accordingly, an output signal corresponding to correct tactile information can be transmitted and a reaction speed can be increased.

In addition, the present invention can use a remarkably wide frequency bandwidth by using the UWB wireless communication technique, as compared to the narrow-band wireless communication technique. Furthermore, since the tactile sensor module of the present invention transmits signals using pulses, transmission power density is low, and thus communication can be performed with small power, rapid transmission and multi-access can be achieved and interference caused by multiple paths can be restrained.

Moreover, when the large-area tactile sensor employing the UWB based tactile sensor module is attached to the surface of a robot, a large number of output signals sensed by the sensing unit can be transmitted to the robot. The tactile sensor and the robot are connected to each other through a UWB communication network without using an additional wire, and thus the robot rapidly reacts to a force applied to the sensing unit and can be controlled in real time.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a tactile sensor module having a UWB wireless communication function, which is connected to an external electronic device through UWB wireless communication;

FIG. 2 is a block diagram showing the tactile sensor module having the UWB wireless communication function illustrated in FIG. 1 in more detail;

FIG. 3 illustrates signal flow between components controlled by a controller;

FIG. 4 is a cross-sectional view of a sensor cell;

FIG. 5 is a cross-sectional view of a tactile sensor included in the sensor cell illustrated in FIG. 4;

FIG. 6 is a plan view of the tactile sensor module having the UWB wireless communication function, which includes a sensing unit having a plurality of sensor cells and a UWB wireless communication unit connected to the sensing unit;

FIG. 7 is a perspective view of a large-area tactile sensor to which the tactile sensor module having the UWB wireless communication function is applied;

FIG. 8 is a perspective view of a robot to which a large-area tactile sensor employing the tactile sensor module having the UWB wireless communication function is attached;

FIG. 9 is a perspective view of a mobile communication terminal to which a large-area tactile sensor employing the tactile sensor module having the UWB wireless communication function is attached; and

FIG. 10 is a flowchart of a UWB wireless communication method using the tactile sensor module having the UWB wireless communication function.

### DETAILED DESCRIPTION OF THE PREFERRED EMBODIMENT

Hereinafter, the present invention will be described in detail by explaining preferred embodiments of the invention with reference to the attached drawings.

<Configuration of Tactile Sensor Module Having UWB Wireless Communication Function>

The present invention provides a tactile sensor module having a UWB wireless communication function, which includes a sensing unit connected to an external electronic device through a UWB wireless communication unit employing an ultra-high speed wireless technique. The configuration and basic function of the tactile sensor module having the UWB wireless communication function will now be explained.

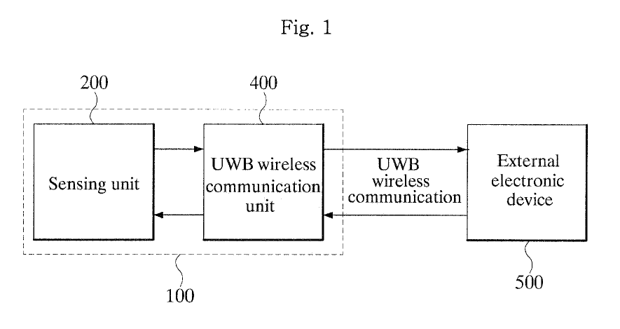

FIG. 1 is a block diagram of the tactile sensor module 100 having the UWB wireless communication function, which is connected to the external electronic device 500 through a UWB wireless communication network. Referring to FIG. 1, when a user applies a force to the sensing unit 200 by using a pointing object, the sensing unit 200 outputs tactile information on the applied force as an output signal. The sensing unit 200 and the external electronic device 500 are wirelessly connected to each other through the UWB wireless communication unit 400 according to a UWB technique. Accordingly, the output signal including the tactile information output from the sensing unit 200 is transmitted to the external electronic device 500 as a UWB wireless communication signal.

The UWB technique means a communication technique using a wide frequency band in a broad sense, which has been studied for military purposes in the United States from 1950s. Since 1994, military security has been removed and some ventures and research institutes have developed UWB wireless technique for commercial purposes. Federal communications commission (FCC) of the United States approved commercial utilization of the UWB wireless technique on Feb. 14, 2002. Standardization of UWB wireless technique is being carried out by IEEE (Institute of Electrical and Electronics Engineers) 802.15 WG (Working Group). UWB defined by FCC means a wireless transmission technique that uses a frequency having a bandwidth of more than 20% of a central frequency or a bandwidth of higher than 500 MHz. Here, the bandwidth is based on −10 dB, distinguished from other communications that set −3 dB as a basis. The UWB transmits data without using a carrier by using a very short baseband pulse corresponding to several nano seconds, which is distinguished from the existing narrow band communication that loads a baseband signal on a carrier to transmit data. Since a UWB pulse corresponding to several nano seconds in time axis domain has a wideband corresponding to a giga band on the frequency spectrum, the UWB is a wireless communication technique having a frequency bandwidth much wider than that of the existing narrow band wireless communication technique. The UWB transmits signals using pulses basically, and thus it has low transmission power density. This enables low-power communication, rapid transmission and multi-access and restrains interference caused by multi-path.

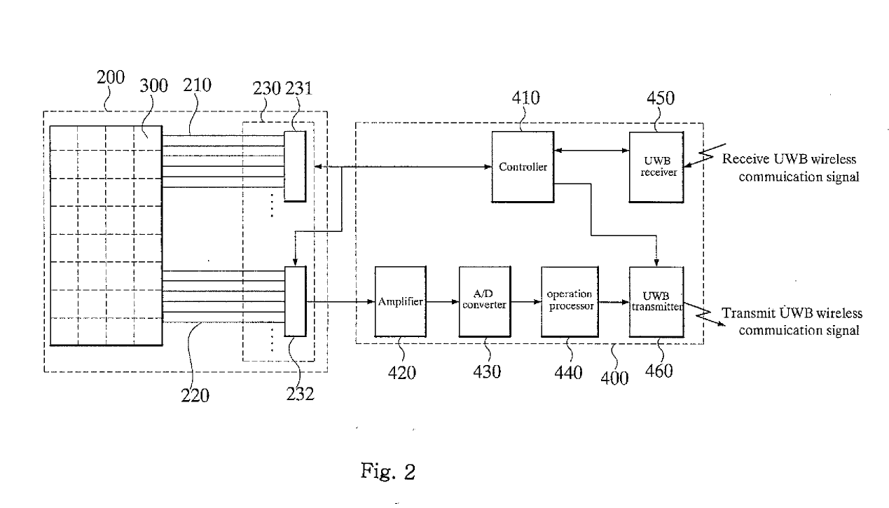

FIG. 2 is a block diagram showing the tactile sensor module 100 having the UWB wireless communication function in more detail. The sensing unit 200 includes a plurality of sensor cells 300. Each sensor cell 300 includes at least one tactile sensor and is connected to a first multiplexer 231 and a second multiplexer 232. Input signal lines 210 of the first multiplexer 231 and output signal lines 220 of the second multiplexer 232 have a matrix form, as illustrated in FIG. 2. The first multiplexer 231 is connected to each of the plurality of sensor cells 300 through the input signal lines 210 and the second multiplexer 232 is connected to each of the plurality of sensor cells 300 through the output signal lines 220.

When a predetermined force is applied to a specific sensor cell 300, a controller 410 transmits a control signal to the first multiplexer 231 and the second multiplexer 232 connected to the specific sensor cell 300 and controls the input signal lines of the first multiplexer 231 connected to the specific sensor cell 300 and the output signal lines of the second multiplexer 232 connected to the specific sensor cell 300 to obtain signal information data on the specific sensor cell 300. Here, the input signal lines and output signal lines connected to each of sensor cells other than the specific sensor cell are grounded. The second multiplexer 232 outputs an output signal corresponding to tactile information obtained from the signal information data. The output signal represents a value in proportion to the strength of the force applied to the specific sensor cell 300 (signal difference is also proportional to the applied force).

A multiplexer 230 including the first and second multiplexers 231 and 232 connected to each of the plurality of sensor cells 300 is included in the sensing unit 200. The output signal output from the second multiplexer 232 is transmitted to the UWB wireless communication unit 400. The UWB wireless communication unit 400 may include an amplifier 420. The amplifier 420 amplifies the output signal output from the multiplexer 230 to a predetermined level. The amplifier 420 may use various amplifiers such as an analog amplifier, a digital amplifier and a voltage amplifier. A noise removal unit (not shown) for removing noise included in the output signal, for example, a bandpass filter or a low pass filter, may be added. A reaction force can be efficiently produced by removing the noise. The UWB wireless communication unit 400 includes an analog-to-digital (A/D) converter 430 for digitalizing the output signal, as illustrated in FIG. 2.

The digitalized output signal (digital signal) is transmitted to an operation processor 440. The operation processor 440 converts the digital signal corresponding to the force applied to the sensing unit 200 into data that can be recognized by the external electronic device 500. The operation performed by the operation processor 440 is determined according to the type of the external electronic device 500 capable of constructing a UWB communication network and information processed by a central processing unit of the external electronic device 500. The UWB wireless communication unit 400 includes a UWB receiver 450 and a UWB transmitter 460. The UWB receiver 450 receives external data in the form of a UWB wireless communication signal from the external electronic device 500 capable of constructing the UWB communication network. When the UWB receiver 450 receives the external data in the UWB wireless communication signal form, the UWB unit 400 and the external electronic unit 500 constructs the UWB communication network.

The controller 410 transmits a control signal to the UWB transmitter 460 to transmit the data converted by the operation processor 440 to the external electronic device 500 as a UWB wireless communication signal. The external data received by the UWB receiver 450 has a UWB wireless communication signal form. Furthermore, the converted data in the UWB wireless communication signal form, sent from the UWB transmitter 460, is transmitted to the external electronic device 500.

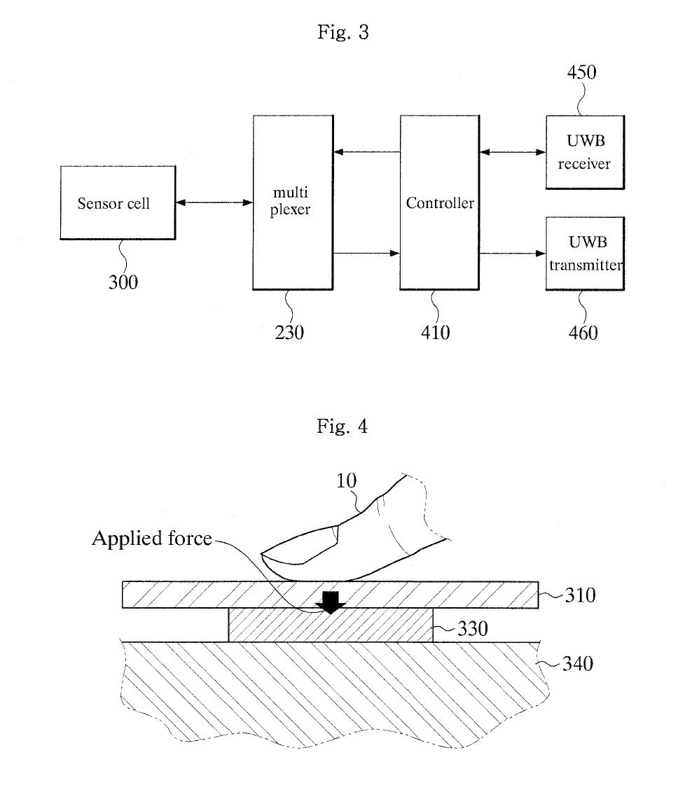

FIG. 3 illustrates signal flow between components controlled by the controller 410. Referring to FIG. 3, the controller 410 receives the external data in the form of a UWB wireless communication signal. In addition, the controller 410 receives tactile information applied to a specific sensor cell 300 from the multiplexer 230 and controls the multiplexer 230 to output an output signal corresponding to the tactile information to the A/D converter 430. Furthermore, the controller 410 controls the UWB transmitter 460 to transmit the converted data received from the operation processor 440 to the external electronic device 500 as a UWB wireless communication signal.

The UWB communication network constructed using the UWB wireless communication unit 400 has information exchange capability within an approximately 20-meter radius. The UWB wireless technique can be used together with the existing frequency band without interfering the existing frequency band and can have a wide frequency bandwidth at a rate of hundreds of Mbps (for example, 200 Mbps), which corresponds to several hundred times the rate (1 Mbps) of the currently widely used short-distance wireless communication Bluetooth. Furthermore, the UWB requires low power consumption corresponding to a quarter of the power consumption of Bluetooth and can pass through walls and ground.

The UWB transmitter 460 may include a look-up table having orthogonal codewords corresponding to n bits divided from a bit stream of the converted data, an OFDM modulator receiving a codeword stream obtained from the bit stream with reference to the look-up table and OFDM-modulating the codeword stream to generate OFDM signals, a UWB modulator generating carriers having a predetermined central frequency for generating UWB wireless communication signals and loading the OFDM signals on the carriers to generate the UWB wireless communication signals, and an antenna transmitting the UWB wireless communication signals to a wireless transmission medium. The OFDM modulator may use BPSK method for constellation mapping in each sub-channel. The technical characteristic of the present invention is that the sensing unit 200 and the external electronic device 500 are connected to each other through UWB wireless communication, and thus the configuration and transmitting method of the UWB transmitter can be varied or modified within the scope of the present invention.

A UWB receiving method includes a step of obtaining OFDM signals from external data in the form of a UWB wireless communication signal and OFDM-demodulating the OFDM signals to obtain a codeword stream and a step of finding n bits corresponding to each of codewords constructing the codeword stream to obtain a bit stream. The OFDM signals are obtained by generating sine waves having the same frequency as carriers of received UWB wireless communication signals and mixing the UWB wireless communication signals with the sine waves. The OFDM signals may be generated through BPSK constellation mapping. The UWB receiver 450 according to an embodiment of the present invention includes an antenna receiving external data in the form of a UWB wireless communication signal from the external electronic device 500, an UWB demodulator for obtaining OFDM signals from received UWB wireless communication signals, an OFDM demodulator for obtaining a codeword stream from the OFDM signals, and a correlator for obtaining a bit stream from the codeword stream.

The UWB communication technique includes MB OFDM and DS CDMA. The UWB communication technique may have characteristics of both the MB OFDM and DS CDMA. The MB OFDM divides a band in the range of 3.1 to 10.6 GHz into 528 MHz bands. Information is transmitted and received as a UWB wireless communication signal in each band according to OFDM. OFDM carriers are effectively generated using 128-point IFFT/FFT (Inverse Fast Fourier Transform/Fast Fourier Transform). Information bits are embedded in all the bands, and thus the information bits can use frequency diversity become robust to multi-path and interference. 60.6 ns prefix can provide robustness even in the worst channel environment. A guard interval of 9.5 ns provides sufficient time for switching of bands. UWB frequency allocation and UWB transmitter structure in the MB OFDM are well known in the art so that explanations thereof are omitted.

The DS CDMA divides a band in the range of 3.1 to 10.6 GHz into bands in the range of 3.1 to 5.15 GHz and bands in the range of 5.825 to 10.6 GHz. Bit streams are frequency-spread according to DS CDMA in each band, loaded on carriers and transmitted as the UWB wireless communication signals. When a single or multiple bits are input, the DS CDMA outputs codewords corresponding to the bit (or bits) from a table composed of orthogonal codewords, which is distinguished from mobile communication using pseudo noise. Codewords mapped to bits are composed of a plurality of ternary codes. One of the ternary codes has a value of 1, −1 or 0. UWB frequency allocation and UWB transmitter structure of the DS CDMA are well known in the art so that explanations thereof are omitted.

A conventional tactile sensor module is constructed in such a manner that a plurality of sensor cells included in a sensing unit are directly connected to an electronic device through signal lines, and thus the conventional tactile sensor module requires a complicated wiring structure and directly transmit/receive a large amount of data so as to decrease a transmission/receiving rate and deteriorate utilization of sensors. However, the present invention can convert an output signal corresponding tactile information into converted data that can be recognized by the external electronic device 500 through the UWB communication network without using an additional wire such that the UWB transmitter 460 transmits the converted data in the form of a UWB wireless communication signal.

The UWB wireless communication unit 400 may include a power supply which provides power to the UWB transmitter 460, the UWB receiver 450, the operation processor 440 and the controller 410 included in the UWB wireless communication unit 400. The power supply may be a rechargeable secondary cell. The UWB wireless communication unit 400 may include a very small power supply. When the UWB wireless communication unit 400 constructs the UWB communication network with the external electronic device 500 without having an additional power supply unit, the external electronic device 500 may supply power.

<Configuration of Sensing Unit>

The sensing unit 200 includes the plurality of sensor cells 300. The sensor cells 300 are connected through signal lines. Furthermore, the sensor cells 300 are connected to the first multiplexer 231 through the input signal lines 210 and connected to the second multiplexer 232 through the output signal lines 220.

The plurality of sensor cells 300 constructing the sensing unit 200 may be of a contact resistance type or capacitance type. Tactile sensors included in contact resistance type sensor cells include resistors. The controller controls the multiplexer 230 to scan the input signal lines 210 connected to the sensor cells 300 and the output signal lines 220 connected to the sensor cells 300 to obtain signal information data. The signal information data represents a resistance variation in an applied force. Configurations of the sensing unit having contact resistance type sensor cells and the multiplexer are well known in the art so that explanation thereof is omitted.

Tactile sensors included in capacitance type sensor cells include capacitors. The controller controls the multiplexer 230 to scan the input signal lines 210 connected to the sensor cells 300 and the output signal lines 220 connected to the sensor cells 300 to obtain signal information data. The signal information data represents a capacitance variation in an applied force. Configurations of the sensing unit having capacitance type sensor cells and the multiplexer are well known in the art so that explanation thereof is omitted.

FIG. 4 is a cross-sectional view showing a configuration of the sensor cell 300. The sensor cell 300 includes a tactile sensor 330 and an actuator 320. The sensor cell 300 further includes a flexible base plate 310 that is a medium recognizing tactile information on a force applied to the sensor cell 300 by a pointing object 10. The tactile sensor 330 is located under the flexible base plate 310, senses the applied force and is connected to the multiplexer 230 illustrated in FIG. 2. The base plate 310 is not additionally provided and the surface of a touch screen, a robot or a display may be the base plate 310 when the tactile sensor module 100 having the UWB wireless communication function is directly attached to the external electronic device 500.

Preferably, the actuator 320 generates vibrations such that a user feels clicking when he/she applies a force to the sensor cell 300. The controller 410 included in the UWB wireless communication unit 400 transmits a driving control signal for driving the actuator 320 to the multiplexer 230 to drive the actuator 320 based on external data in the form of a UWB wireless communication signal, transmitted to the UWB receiver 450 from the external electronic device 500, and the output signal including tactile information output from the multiplexer 230. While the actuator 320 is located on the tactile sensor 330 in FIG. 4, the actuator 320 may be located under the tactile sensor 330. Furthermore, connection of the actuator 320 and the tactile sensor 330 is well known in the art so that explanation thereof is omitted.

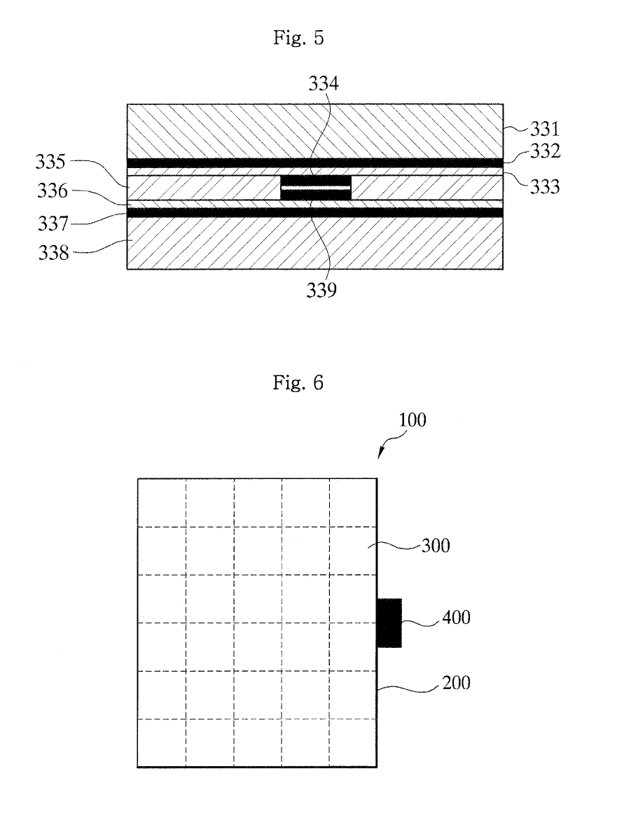

FIG. 5 is a cross-sectional view of the tactile sensor 330 included in the sensor cell 300 illustrated in FIG. 4. The tactile sensor 330 included in the sensor cell 300 includes an upper plate and a lower plate. The upper plate is manufactured in such a manner that a coating layer 332 and a metal layer 333 are sequentially formed on a polymer film 331 having a predetermined thickness and a resistor 334 is formed on the metal layer 333. The lower plate is manufactured in such a manner that a coating layer 337 and a metal layer 336 are sequentially formed on a polymer film 338 having a predetermined thickness and a resistor 339 is formed on the metal layer 336. The upper plate and the lower plate are bonded to each other having a spacer 335 interposed therebetween and the resistors 334 and 339 facing each other.

The controller 410 included in the UWB wireless communication unit 400 receives an output signal corresponding to tactile information calculated based on a force applied to the sensor cell 300 from the multiplexer 230 and transmits a driving control signal for driving the actuator 320 to the multiplexer 230 to drive the actuator 320. The controller 410 may be a very small microcomputer, CPU or dedicated chip set, which can be easily set in the UWB wireless communication unit 400.

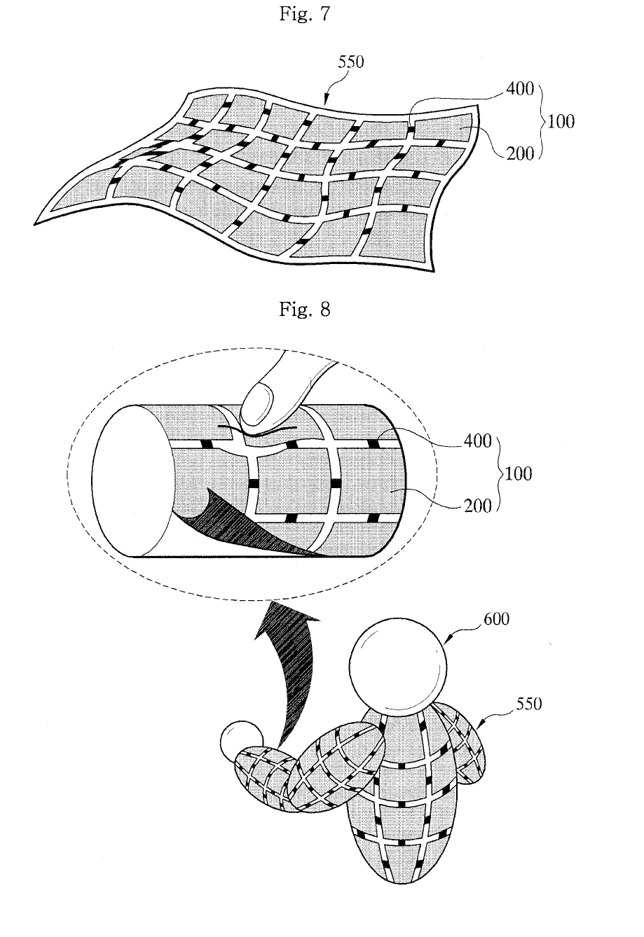

FIG. 6 is a plan view showing the tactile sensor module 100 having the UWB wireless communication function, which includes the sensing unit 200 having the plurality of sensor cells 300 and the UWB wireless communication unit 400 connected to the sensing unit 200. It is possible to construct a large-area tactile sensor 550 by connecting a plurality of tactile sensor modules 100 having the UWB wireless communication function, as illustrated in FIG. 7.

FIG. 7 is a perspective view of the large-area tactile sensor 550 employing the tactile sensor module 100 having the UWB wireless communication function. The large-area tactile sensor 550 includes a plurality of tactile sensor modules 100 having the UWB wireless communication function and is thin and flexible like vinyl.

The large-area tactile sensor 550 including the tactile sensor modules 100 having the UWB wireless communication function is bonded to the external electronic device 500. Though a conventional sensing unit having sensor cells is connected to the electronic device by wire, the tactile sensor 550 according to the present invention is connected to the electronic device through bonding without using a wire since the tactile sensor 550 is composed of the tactile sensor modules 100 having the UWB wireless communication function, each of which includes the sensing unit 200 connected to the UWB wireless communication unit 400, and thus a large amount of data can be transmitted to the external electronic device 500 at a very high speed through UWB.

FIG. 8 is a perspective view of a robot 600 to which the large-area tactile sensor 550 employing the tactile sensor module 100 having the UWB wireless communication function is attached. As illustrated in FIG. 8, the large-area tactile sensor 550 employing the tactile sensor module 100 having the UWB wireless communication function is attached to the surface of the robot 600. There is no need to connect the large-area tactile sensor 550 with the robot 600 by wire. That is, a signal corresponding to tactile information, output from the large-area tactile sensor 550, is converted into data that can be recognized by a central processing unit of the robot 600 and transmitted as a UWB wireless communication signal to the robot 600 according to the UWB transmitter 460, and thus the robot 600 can move in response to a force applied to the sensing unit 200 without having an additional wire connecting the large-area tactile sensor 550 with the robot 600.

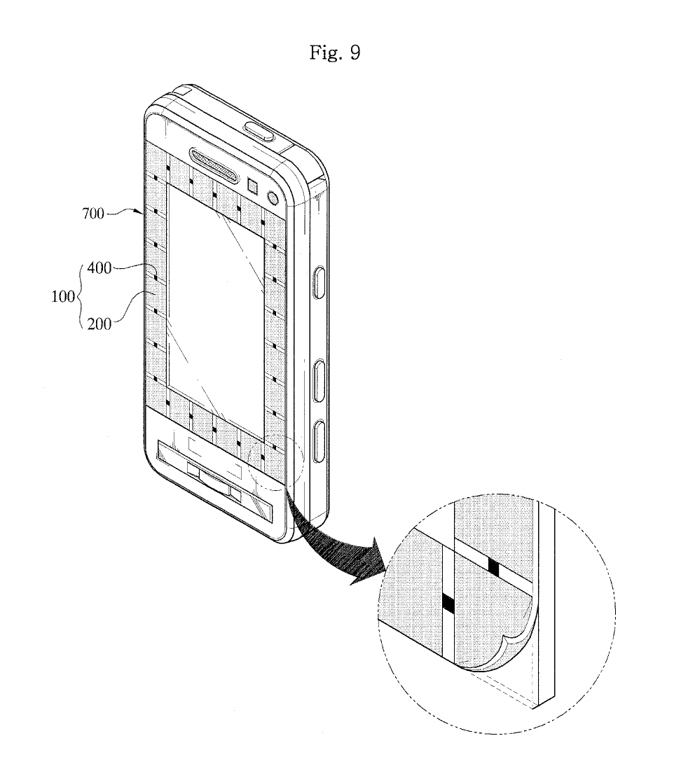

FIG. 9 is a perspective view of a mobile communication terminal 700 to which the large-area tactile sensor 550 employing the tactile sensor module 100 having the UWB wireless communication function is attached. As illustrated in FIG. 9, the large-area tactile sensor 550 is attached to a display of the terminal 700. The display may be a flexible touch screen. The large-area tactile sensor 500 may be attached to the marginal region of the touch screen in order to prevent the display function of the touch screen from deteriorating.

Accordingly, even when a force is applied to multiple points by using the pointing object 10 through multi-touch or dragging, force applied to each point can be sensed. The mobile communication terminal 700 and the large-area tactile sensor 550 do not require an additional electric wire connecting them to each other. The large-area tactile sensor 550 is connected to the mobile communication terminal 700 through a UWB network, and thus the operation processor 440 included in the UWB wireless communication unit 400 converts an output signal corresponding to tactile information sensed by the sensing unit into data that can be recognized by the mobile communication terminal 700 and the UWB transmitter 460 transmits the data in the form of a UWB wireless communication signal to the mobile communication terminal 700 to provide various interfaces to the user.

<UWB Communication Method Using Tactile Sensor Module Having UWB Wireless Communication Function>

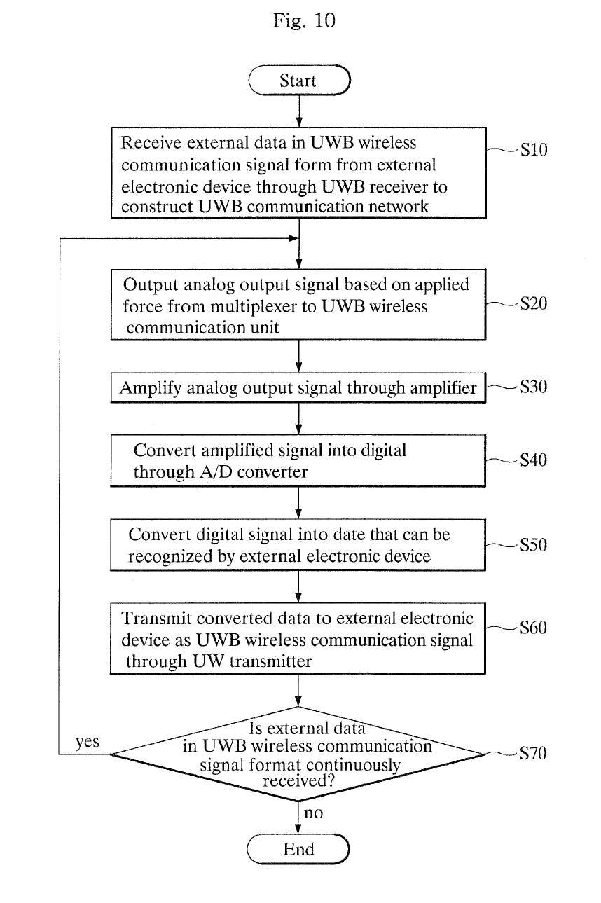

A UWB communication method using the tactile sensor module 100 having the UWB wireless communication function according to an embodiment of the present invention will now be explained with reference to the attached drawings. FIG. 10 is a flowchart of the UWB communication method using the tactile sensor module 100 having the UWB wireless communication function.

The UWB receiver 450 receives external data in the form of a UWB wireless communication signal from the external electronic device 500 such that the sensing unit 200 and the external electronic device 500 are connected to each other by using the UWB wireless communication unit 400 through a UWB network in step S10. The controller 410 included in the UWB wireless communication unit 400 controls the multiplexer 230 to output an output signal corresponding to tactile information from the multiplexer 230. The controller 410 scans an input signal line of the first multiplexer, which is connected to a specific sensor cell, and an output signal line of the second multiplexer, which is connected to the specific sensor cell, to obtain signal information data. In this manner, the output signal corresponding to tactile information obtained from signal information data each of the plurality of sensor cells is output in step S20.

An analog output signal output from the second multiplexer is transmitted to the UWB wireless communication unit 400 and amplified by the amplifier 420 included in the UWB wireless communication unit 400 in step S30. The A/D converter 430 included in the UWB wireless communication unit 400 converts the analog output signal into a digital signal in step S40. The operation processor 440 converts the digital signal into data that can be recognized by the external electronic device 500 in step S50. Here, the digital signal is converted into data that can be recognized by the external electronic device 500 according to the type of the external electronic device 500 capable of constructing a UWB network and the central processing unit of the external electronic device 500.

The UWB transmitter 460 receives the converted data and the controller 410 controls the UWB transmitter 460 to transmit the converted data to the external electronic device 500 as a UWB wireless communication signal in step S60. The aforementioned operation is repeated if the UWB receiver 450 continuously receives external data in the form of a UWB wireless communication signal from the external electronic device 500 and the aforementioned operation is finished if there is no external data transmitted to the UWB receiver 450 from the external electronic device 500 in step S70.

As described above, signals are transmitted from the sensing unit 200 to the external electronic device 500 in such a manner that an output signal having tactile information sensed by the sensing unit 200 is converted into data that can be recognized by the external electronic device 500 and transmitted as a UWB wireless communication signal to the external electronic device 500 from the UWB transmitter in real time, and thus a large number of output signals sensed by the sensing unit 200 can be transmitted to the external electronic device 500 without connecting the sensing unit 200 to the external electronic device 500 by using an electric wire. In an embodiment of the present invention, the external electronic device 500 corresponds to the robot 600 or the mobile communication terminal 700. However, UWB wireless communication can be applied to any electronic device 500, and thus the type of the external electronic device 500 is not limited if the external electronic device can perform UWB wireless communication.

Particularly, when a conventional tactile sensor is connected to the robot 600 by wire, a vast number of signal lines are required, and thus a transmission speed of output signals of the tactile sensor and a reaction speed of the robot 600 are decreased. However, the present invention attaches the large-area tactile sensor 550 employing the tactile sensor module 100 having the UWB wireless communication function to the surface of the robot 600 to connect the sensing unit 200 and the robot 600 through a UWB network, converts an output signal from the tactile sensor 550 into data that can be recognized by the robot 600 and transmits the data to the robot 600 as a UWB wireless communication signal in real time. Accordingly, the present invention can transmit a vast amount of data and increase the reaction speed of the robot 600.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A tactile sensor module having an ultra-wideband (UWB) wireless communication function, comprising:
a sensing unit having a plurality of sensor cells sensing an external force applied thereto and outputting an output signal based on tactile information in proportion to the applied force; and
a UWB wireless communication unit receiving the output signal, converting the received signal into a UWB wireless communication signal and transmitting the UWB wireless communication signal,
wherein the UWB wireless communication unit comprises a UWB receiver receiving external data in the form of a UWB wireless communication signal from an external electronic device and a UWB transmitter transmitting the output signal converted into the UWB wireless communication signal to the external electronic device.

2. The tactile sensor module of claim 1, wherein the sensing unit is of a contact resistance type.

3. The tactile sensor module of claim 1, wherein the sensing unit is of a capacitance type.

4. The tactile sensor module of claim 1, wherein the sensing unit further includes a multiplexer which has a matrix form, is connected to each of the plurality of sensor cells and transmits the output signal corresponding to the tactile information based on the applied force to the UWB wireless communication unit.

5. The tactile sensor module of claim 4, wherein the multiplexer comprises a first multiplexer connected to each of the plurality of sensor cells through input signal lines and a second multiplexer connected to each of the plurality of sensor cells through output signal lines, each of the input signal lines has two terminals respectively capable of selecting an input and ground and each of the output signal lines has two terminal respectively capable of selecting an output and ground.

6. The tactile sensor module of claim 5, wherein the UWB wireless communication unit further comprises an amplifier receiving the output signal and amplifying the output signal and an A/D converter converting the amplified output signal into a digital signal.

7. The tactile sensor module of claim 6, wherein the UWB wireless communication unit further comprises an operation processor converting the digital signal converted by the A/D converter into data that can be recognized by the external electronic device and transmitting the converted data to the UWB transmitter.

8. The tactile sensor module of claim 7, wherein the UWB wireless communication unit further comprises a controller which receives the UWB wireless communication signal received by the UWB receiver, controls the UWB transmitter to transmit the data converted by the operation processor to the external electronic device as a UWB wireless communication signal and controls the multiplexer to output the output signal to the UWB wireless communication unit.

9. The tactile sensor module of claim 8, further comprising a power supply supplying power to the UWB wireless communication unit.

10. The tactile sensor module of claim 1, wherein the external electronic device is a robot capable of performing UWB wireless communication with the tactile sensor module.

11. The tactile sensor module of claim 10, wherein the robot has a plurality of tactile sensor modules having the UWB wireless communication function, which are attached to the surface of the robot, and an output signal corresponding to tactile information based on a force applied to the sensing unit is transmitted to the robot as UWB wireless communication signal to operate the robot.

12. The tactile sensor module of claim 1, wherein the external electronic device is a mobile communication terminal capable of performing UWB wireless communication with the tactile sensor module.

13. The tactile sensor module of claim 12, wherein a touch screen of the mobile communication terminal includes a plurality of tactile sensor modules having the UWB wireless communication function and an output signal corresponding to tactile information based on a force applied to the sensing unit is transmitted to the mobile communication terminal as a UWB wireless communication signal to provide various interfaces to a user.

14. A UWB communication method using a tactile sensor module having a UWB wireless communication function, comprising the steps of:
receiving external data in the form of a UWB wireless communication signal from an external electronic device through a UWB receiver and constructing a UWB wireless communication network between a sensing unit and the external electronic device through a UWB wireless communication unit;
controlling a first multiplexer connected to a plurality of sensor cells of the sensing unit through input signal lines and a second multiplexer connected to the plurality of sensor cells through output signal lines to scan the input signal lines and the output signal lines to obtain signal information data and outputting an output signal corresponding to tactile information based on the signal information data from the second multiplexer;
amplifying the output signal output from the second multiplexer;
converting the amplified output signal into a digital signal;
converting the digital signal into data that can be recognized by the external electronic device; and
transmitting the converted data to a UWB transmitter and controlling the UWB transmitter to transmit the converted data to the external electronic device as a UWB wireless communication signal.

15. The UWB communication method of claim 14, wherein the external electronic device is a robot capable of performing UWB wireless communication with the tactile sensor module having the UWB wireless communication function.

16. The UWB communication method of claim 15, wherein the robot has a plurality of tactile sensor modules having the UWB wireless communication function, which are attached to the surface of the robot, and an output signal corresponding to tactile information based on a force applied to the sensing unit is transmitted to the robot to operate the robot.

17. The UWB communication method of claim 14, wherein the external electronic device is a mobile communication terminal capable of performing UWB wireless communication with the tactile sensor module having the UWB wireless communication function.

18. The UWB communication method of claim 17, wherein a touch screen of the mobile communication terminal includes a plurality of tactile sensor modules having the UWB wireless communication function and an output signal corresponding to tactile information based on a force applied to the sensing unit is transmitted to the mobile communication terminal to provide various interfaces to a user.
